(19) United States
(12) Patent Application Publication
(10) Pub. No.: US 2020/0404868 A1
(43) Pub. Date: Dec. 31, 2020

(54) FLUID RETENTION ASSEMBLY

(71) Applicant: Donald Adams, Aptos, CA (US)

(72) Inventor: Donald Adams, Aptos, CA (US)

(21) Appl. No.: 16/453,229

(22) Filed: Jun. 26, 2019

(51) Int. Cl. A01G 27/02; A01G 27/00; A01G 9/02

(52) U.S. Cl. CPC A01G 27/02; A01G 9/02; A01G 27/008

(57) ABSTRACT

A fluid retention assembly includes a housing that may be positioned on a support surface. The housing is located proximate a downspout of a building. The housing has an upper section removably coupled to a bottom section of the housing. A lip is coupled to and extends outwardly from the outer wall of the bottom section. A spout extends through the housing to be directed into the downspout. The fluid enters the fluid opening, allowing the spout to capture the fluid. A first hose is fluidly coupled to the spout, directing the fluid into the housing. A pump is positioned within the bottom section of the housing. The pump is immersed in the fluid when the fluid is directed into the bottom section. A spigot is coupled to the housing. A second hose is fluidly coupled between the spigot the pump. The pump urges the fluid outwardly through the spigot. A power supply is electrically coupled to the pump.

### BACKGROUND OF THE DISCLOSURE

### Field of the Disclosure

The disclosure relates to retention devices and more particularly pertains to a new retention device for retaining a fluid and serving as a planter.

### SUMMARY OF THE DISCLOSURE

An embodiment of the disclosure meets the needs presented above by generally comprising a housing that may be positioned on a support surface. The housing is located proximate a downspout of a building. The housing has an upper section removably coupled to a bottom section of the housing. A lip is coupled to and extends outwardly from the outer wall of the bottom section. A spout extends through the housing to be directed into the downspout. The fluid enters the fluid opening, allowing the spout to capture the fluid. A first hose is fluidly coupled to the spout, directing the fluid into the housing. A pump is positioned within the bottom section of the housing. The pump is immersed in the fluid when the fluid is directed into the bottom section. A spigot is coupled to the housing. A second hose is fluidly coupled between the spigot the pump. The pump urges the fluid outwardly through the spigot. A power supply is electrically coupled to the pump.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a fluid retention assembly according to an embodiment of the disclosure.

FIG. 2 is a left side view of an embodiment of the disclosure.

FIG. 3 is a back view of an embodiment of the disclosure.

FIG. 4 is a cross sectional view taken along line 4-4 of FIG. 3 of an embodiment of the disclosure.

FIG. 5 is a top perspective view of an alternative embodiment of the disclosure.

### DESCRIPTION OF THE PREFERRED EMBODIMENT

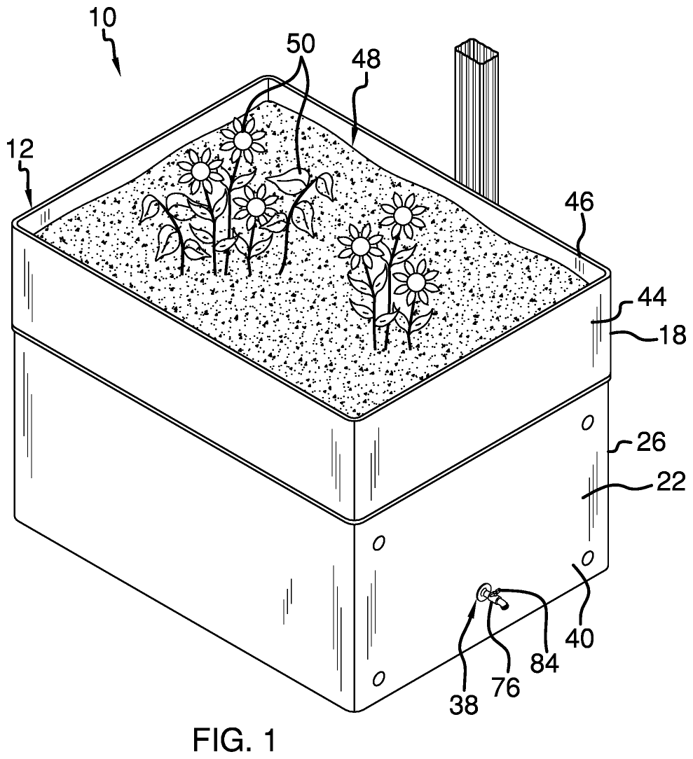

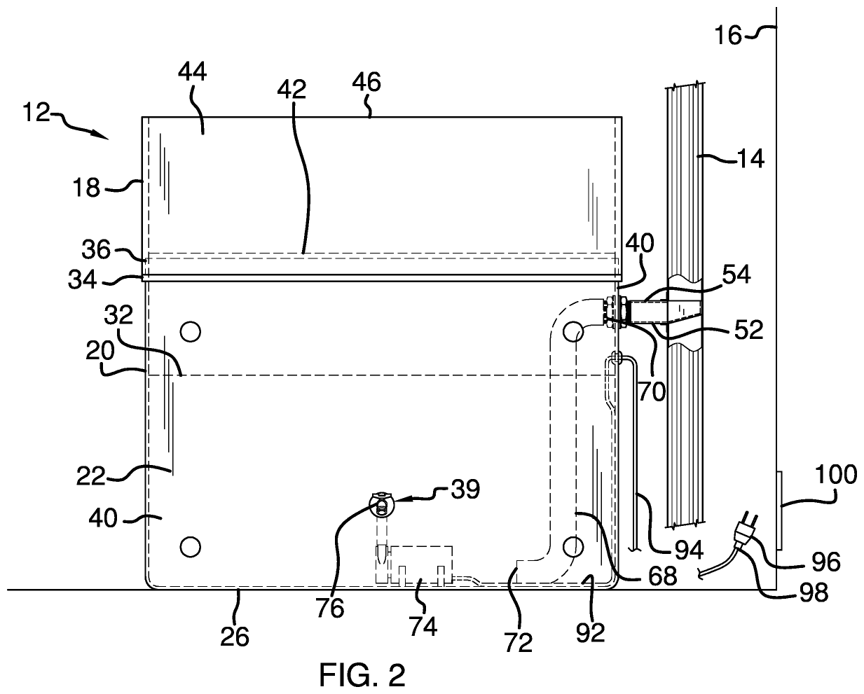

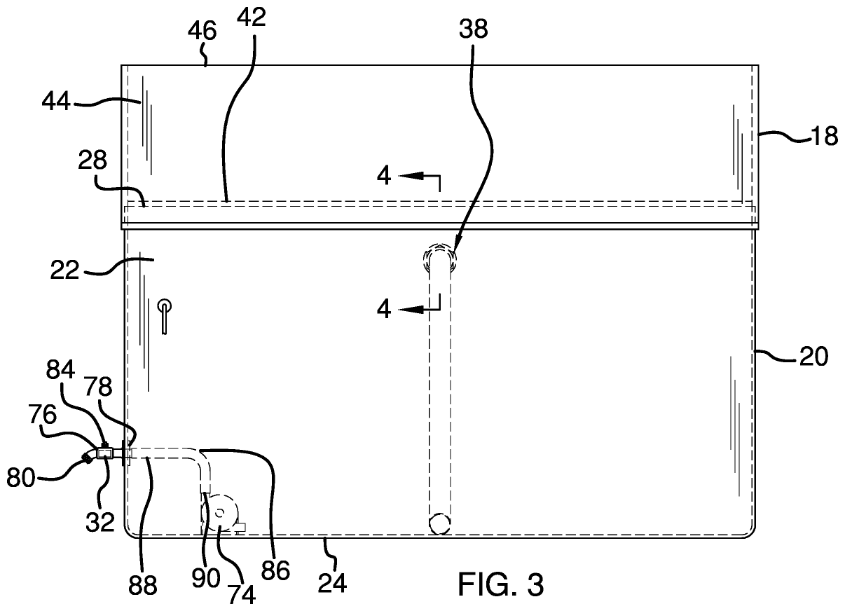

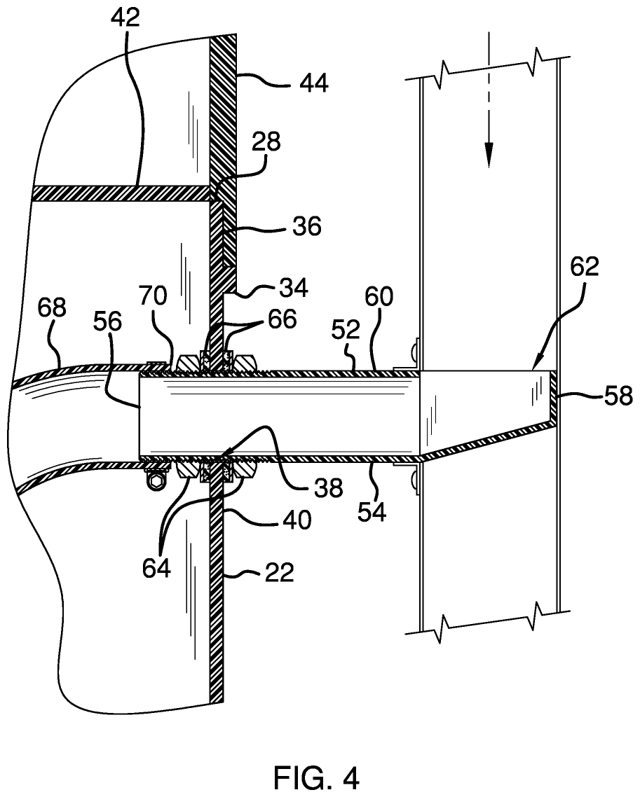

With reference now to the drawings, and in particular to FIGS. 1 through 5 thereof, a new retention device embodying the principles and concepts of an embodiment of the disclosure and generally designated by the reference numeral 10 will be described.

As best illustrated in FIGS. 1 through 5, the fluid retention assembly 10 generally comprises a housing 12 that may be positioned on a support surface 14 such that the housing 12 is located proximate a downspout 14 of a building 16. The support surface 14 may be ground. The downspout 14 may be a gutter downspout or the like.

The housing 12 has an upper section 18 removably coupled to a bottom section 20 of the housing 12. The bottom section 20 has an outer wall 22 coupled to and extending upwardly from an outer edge 24 of a bottom wall 26 of the bottom section 20. A top edge 28 of the outer wall 22 defines an opening 30 into an interior of the bottom section 20. The bottom section 20 of the housing 12 may contain a fluid 32. The fluid 32 may be rain water.

A lip 34 is coupled to and extends outwardly from the outer wall 22 of the bottom section 20. The lip 34 is positioned closer to the top edge 28 of the outer wall 22 than the bottom wall 26 of the bottom section 20. The lip 34 is continuous and forms a receiver 36 to receive the top edge 28 of the bottom section 20.

The outer wall 22 has a spout opening 38 extending therethrough. The spout opening 38 is positioned on a back side 40 of the outer wall 22 proximate the top edge 28 of the outer wall 22. Additionally, the outer wall 22 has a spigot opening 39 extending therethrough. The spigot opening 39 is positioned on a first lateral side 40 of the outer wall 22 proximate the bottom wall 26.

The upper section 18 has a lower wall 42 and an outermost wall 44 coupled to and extending upwardly from the lower wall 42. A topmost edge 46 of the outermost wall 44 defines an opening 48 into an interior of the upper section 18. The upper section 18 may contain plant life 50 or other similarly visually appealing material.

A spout 52 is provided. The spout 52 has an exterior wall 54 extending between a first end 56 and a second end 58 of the spout 52. The spout 52 is substantially hollow. The first end 56 of spout 52 is open.

A top side 60 of the exterior wall 54 has a fluid opening 62 extending therethrough. The fluid opening 62 is positioned adjacent to the second end 58. The spout 52 extends through the spout opening 38 such that the first end 56 of the spout 52 is positioned within the housing 12. The second end 58 of the spout 52 may be directed into the downspout 14 such that the fluid 32 enters the fluid opening 62. Thus, the spout 52 captures the fluid 32.

A pair of nuts 64 is provided. Each of the nuts 64 threadably engages the exterior wall 54 of the spout 52. Each of the nuts 64 engages the outer wall 22 of the bottom section 20 to retain the spout 52 in the spout opening 38. A pair of gaskets 66 is each positioned between an associated one of the nuts 64 and the outer wall 22.

A first hose 68 has a first end 70 and a second end 72. The first end 70 of the first hose 68 is fluidly coupled to the first end 56 of the spout 52. The second end 72 of the first hose 68 is positioned within an interior of the bottom section 20. The first hose 68 directs the fluid 32 into the housing 12.

A pump 74 is provided. The pump 74 is positioned within the bottom section 20 of the housing 12 such that the pump 74 is immersed in the fluid 32 when the fluid 32 is collected in the bottom section 20. The pump 74 may be an electric fluid pump of the like.

A spigot 76 has a coupled end 78 and a free end 80. Each of the coupled end 78 and the free end 80 is open. The spigot 76 comprises a valve 82 positioned within the spigot 76. The valve 82 restricts a flow of the fluid 32 through the spigot 76. The spigot 76 extends through the spigot opening 39. A handle 84 is coupled to the valve 82. The handle 84 may be gripped to position the valve 82 between an open position and a closed position. The valve 82 may be a fluid valve or the like.

A second hose 86 has a first end 88 and a second end 90. The first end 88 of the second hose 86 is fluidly coupled to the coupled end 78 of the spigot 76. The second end 90 of the second hose 86 is fluidly coupled to an output 79 of the pump 74. Thus, the pump 74 urges the fluid 32 outwardly through the free end 80 of the spigot 76 when the valve 82 is placed in an open position.

A power supply 92 is electrically coupled to the pump 74. The power supply 92 comprises a cord 94 extending outwardly through the back side 40 of the outer wall 22 of the bottom section 20. The cord 94 has a plug 96 electrically coupled to a distal end 98 of the cord 84 with respect to the pump 74. The plug 96 is electrically coupled to a power source 100. The power source 100 may be an electrical outlet or the like.

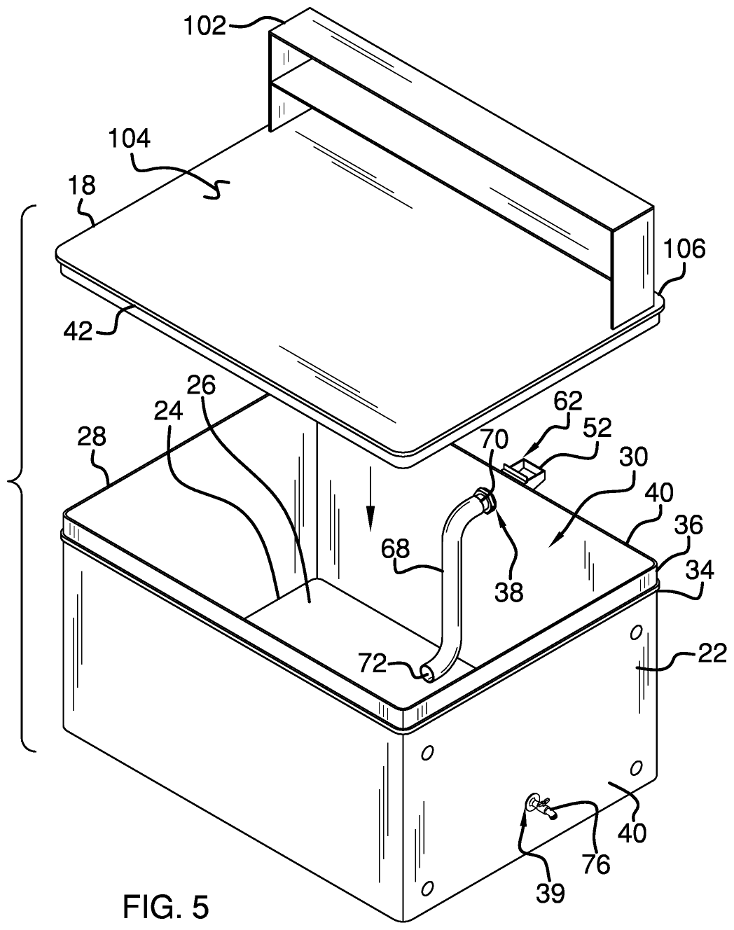

In an alternative embodiment as shown in FIG. 5, the upper section 18 may comprise the lower wall 42. A shelf 102 is coupled to and extends upwardly from a top surface 104 of the lower wall 42. The shelf 102 is coextensive with a back edge 106 of the lower wall 42. The upper section 18 may support a user in the convention of a chair.

In use, the bottom section 20 is utilized to capture the fluid 32 produced by precipitation. The valve 82 on the spigot 76 is opened when the fluid 32 is to be removed from the bottom section 20. The bottom section 20 stores the fluid 32 indefinitely. The upper section 18 may be used as a planter or a seat.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fluid retention assembly configured to contain a fluid and provide a horticultural display, said assembly comprising:
a housing configured to be positioned on a support surface such that said housing is located proximate a downspout of a building, said housing having an upper section removably coupled to a bottom section of said housing;
a lip coupled to and extending outwardly from said outer wall of said bottom section;
a spout extending through said housing wherein said spout is configured to be directed into the downspout such that the fluid enters said fluid opening wherein said spout captures the fluid;
a first hose fluidly coupled to said spout wherein said first hose is configured to direct the fluid into said housing;
a pump positioned within said bottom section of said housing such that said pump is immersed in the fluid when the fluid is directed into said bottom section;
a spigot coupled to said housing;
a second hose fluidly coupled between said spigot said pump wherein said pump urges the fluid outwardly through said spigot; and
a power supply electrically coupled to said pump.

2. The assembly according to claim 1, wherein said bottom section of said housing having an outer wall coupled to and extending upwardly from and outer edge of a bottom wall of said bottom section, a top edge of said outer wall defining an opening into an interior of said bottom section, said bottom section of said housing being configured to contain a fluid.

3. The assembly according to claim 2, further comprising said lip being positioned closer to said top edge of said outer wall than said bottom wall of said bottom section, said lip being continuous and forming a receiver to receive said top edge of said bottom section.

4. The assembly according to claim 3, further comprising said outer wall having a spout opening extending therethrough, said spout opening being positioned on said back side proximate said top edge of said outer wall.

5. The assembly according to claim 3, further comprising said outer wall having a spigot opening extending therethrough, said spigot opening being positioned on said first lateral side proximate said bottom wall.

6. The assembly according to claim 4, further comprising said spout having an exterior wall extending between a first end and a second end of said spout, said spout being substantially hollow, said first end of spout being open, a top side of said exterior wall having a fluid opening extending therethrough, said fluid opening being positioned adjacent to said second end, said spout extending through said spout opening such that said first end is positioned within said housing wherein said second end of said spout is configured to be directed into the downspout.

7. The assembly according to claim 6, further comprising said first hose having a first end and a second end, said first end of said first hose being fluidly coupled to said first end of said spout, said second end of said first hose being positioned within an interior of said bottom section.

8. The assembly according to claim 5, further comprising said spigot having a coupled end and a free end, each of said coupled end and said free end being open, said spigot comprising a valve positioned within said spigot, said valve restricting a flow of the fluid through said spigot, said spigot extending through said spigot opening.

9. The assembly according to claim 8, further comprising said second hose having a first end and a second end, said first end of said second hose being fluidly coupled to said coupled end of said spigot, said second end of said second hose being fluidly coupled to an output of said pump wherein said pump urges the fluid outwardly through said free end of said spigot when said valve is placed in an open position.

10. The assembly according to claim 2, further comprising said power supply comprising a cord extending outwardly through said back side of said outer wall of said bottom section, said cord having a plug electrically coupled to a distal end of said cord with respect to said pump, said plug being electrically coupled to a power source.

11. A fluid retention assembly configured to contain a fluid and provide a horticultural display, said assembly comprising:
a housing configured to be positioned on a support surface such that said housing is located proximate a downspout of a building, said housing having an upper section removably coupled to a bottom section of said housing, said bottom section of said housing having an outer wall coupled to and extending upwardly from and outer edge of a bottom wall of said bottom section, a top edge of said outer wall defining an opening into an interior of said bottom section, said bottom section of said housing being configured to contain a fluid;
a lip coupled to and extending outwardly from said outer wall of said bottom section, said lip being positioned closer to said top edge of said outer wall than said bottom wall of said bottom section, said lip being continuous and forming a receiver to receive said top edge of said bottom section;
said outer wall having a spout opening extending therethrough, said spout opening being positioned on said back side proximate said top edge of said outer wall;
said outer wall having a spigot opening extending therethrough, said spigot opening being positioned on said first lateral side proximate said bottom wall;
said upper section having a lower wall and an outermost wall coupled to and extending upwardly from said lower wall, a topmost edge of said outermost wall defining an opening into an interior of said upper section;
a spout having an exterior wall extending between a first end and a second end of said spout, said spout being substantially hollow, said first end of spout being open, a top side of said exterior wall having a fluid opening extending therethrough, said fluid opening being positioned adjacent to said second end, said spout extending through said spout opening such that said first end is positioned within said housing wherein said second end of said spout is configured to be directed into the downspout such that the fluid enters said fluid opening wherein said spout captures the fluid;
a first hose having a first end and a second end, said first end of said first hose being fluidly coupled to said first end of said spout, said second end of said first hose being positioned within an interior of said bottom section;
a pump positioned within said bottom section of said housing such that said pump is immersed in the fluid when the fluid is directed into said bottom section; and
a spigot having a coupled end and a free end, each of said coupled end and said free end being open, said spigot comprising a valve positioned within said spigot, said valve restricting a flow of the fluid through said spigot, said spigot extending through said spigot opening;
a second hose having a first end and a second end, said first end of said second hose being fluidly coupled to said coupled end of said spigot, said second end of said second hose being fluidly coupled to an output of said pump wherein said pump urges the fluid outwardly through said free end of said spigot when said valve is placed in an open position; and
a power supply electrically coupled to said pump, said power supply comprising a cord extending outwardly through said back side of said outer wall of said bottom section, said cord having a plug electrically coupled to a distal end of said cord with respect to said pump, said plug being electrically coupled to a power source.
